(19) United States
(12) Patent Application Publication
(10) Pub. No.: US 2026/0133990 A1
(43) Pub. Date: May 14, 2026

(54) REVISION MANAGEMENT SYSTEMS AND METHODS

(71) Applicant: Work Packs Inc., Pittsburgh, PA (US)

(72) Inventors: Ted Blackmon, San Diego, CA (US); Jihad El Haj Daoud, Jadra (LB); Rayan Jreije, Athens (GR)

(21) Appl. No.: 19/344,136

(22) Filed: Sep. 29, 2025

Related U.S. Application Data
(60) Provisional application No. 63/719,369, filed on Nov. 12, 2024.

(51) Int. Cl. G06F 16/27; G06F 9/54; G06F 16/22; G06F 16/2455

(52) U.S. Cl. CPC G06F 16/27; G06F 9/542; G06F 16/2282; G06F 16/24565

(57) ABSTRACT

Embodiments of the present disclosure include systems and methods for managing revisions in complex projects. Certain embodiments facilitate efficient tracking, monitoring, notifying, and implementation of revisions to project artifacts, such as commodities, drawings, and documents, thereby enhancing collaboration and reducing errors during project execution.

### CROSS REFERENCE TO RELATED APPLICATIONS

This application claims priority to provisional patent application number 63/719,369, filed Nov. 12, 2024, the entire disclosure of which is hereby incorporated herein by reference.

### BACKGROUND

The present disclosure relates generally to computer software systems, and in particular, to revision management systems and methods.

Complex projects, such as construction projects, frequently entail numerous stakeholders and regular revisions to scope and documents. Traditional revision management methods may prove insufficient in meeting the unique demands and complexities of more complex projects, such as those occurring in the construction industry, for example. Traditional approaches often rely on manual updates to logs (e.g., by quantity surveyors) and document management teams. This manual approach necessitates additional workforce, heightened efforts, and significantly increases the risk of human error. Thus, there is a clear necessity for an enhanced system and method for effectively managing revisions.

The following disclosure provides various technical solutions to overcome the above-stated problems.

### BRIEF DESCRIPTION OF THE DRAWINGS

FIG. 1 illustrates an example revision management system according to an embodiment.

FIG. 2A illustrates example monitoring according to an embodiment.

FIG. 2B illustrates an example JSON configuration according to an embodiment.

FIG. 2C illustrates an example raw JSON event captured by the monitoring system for an insertion into a table according to an embodiment.

FIG. 3A illustrates example impact analysis according to an embodiment.

FIG. 3B illustrates example impact analysis according to an embodiment.

FIG. 4 illustrates example notification according to an embodiment.

FIG. 5 illustrates an example process flow according to an embodiment.

FIG. 6 illustrates an example user interface according to an embodiment.

FIG. 7 illustrates hardware of a special purpose computing system configured according to the above disclosure.

FIG. 8 is another example of a system for revision triggers and configurations around a database structure.

FIG. 9 is a Snapshot of a user interface in a document module showing full track history of a single document.

FIG. 10 is a Snapshot of a user interface in a document module showing latest revisions.

FIG. 11 shows a notification generated to the IWP owner/planner with the subject change at the document level.

FIG. 12 illustrates a flow showing tag revision control as part of standard tag loading process

FIG. 13 illustrates a user interface for selecting different automated tag sources along with tag statuses that guarantee tag change control

FIG. 14 illustrates a notification generated to the IWP owner/Workface planner with the tag quantity change (previous/current quantities are shown).

FIG. 15 illustrates a sample of piping change management tracker.

FIG. 16 illustrates automated aggregated notifications sent to construction departments for the current changes in tags based on tag status cycle under their custody.

FIG. 17 illustrates a BOM revision flow storing data to digital threads with time stamps.

### DETAILED DESCRIPTION

Described herein are techniques for revision management. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium (e.g., electronic memory) storing computer-executable instructions that, when executed by at least one processor, perform the methods as described herein and in the following examples.

In the following disclosure, an example system is designed as a comprehensive revision management platform composed of multiple integrated services that collectively manage and communicate database changes to users. Revision management is often referred to as change management and includes mechanisms for tracking and managing changes (e.g., changes impacting a project) occurring in a system, for example. The example system includes multiple independently innovative and advantageous components. For example, the process begins with a monitoring service that tracks changes in the database. The monitoring service may identify specific alterations such as insertions, deletions, and updates at the table level, for example. Based on the type of change detected, the system generates a corresponding list of impacts. An impact identifies the objects and components affected by the change. These impacts are then processed by a notification service, which organizes the data into a notification buffer. The buffer temporarily holds the notifications until they are consumed by the notification aggregator service. The notification aggregator service may be responsible for delivering the aggregated notifications to the relevant users, for example, ensuring they are informed of any changes and their associated impacts in a timely and organized manner. While the following disclosure sets forth an entire system, it is to be understood that one or more system components include innovative technical solutions to technical problems which are combined in the present example. Accordingly, the following example system encompasses a versatile and comprehensive revision management system designed to monitor, assess, and communicate changes within various types of project databases. While the system is applicable across a wide range of industries, the present example design may be advantageous for Advanced Work Packaging (AWP) in the construction sector. The core functionality may include, for example, automated detection of database changes, assessment of their impacts, and structured communication of these impacts to relevant stakeholders. Various innovations include an overall architecture, workflows, and methodologies illustrated in this example system, which are adaptable to different contexts, including but not limited to AWP.

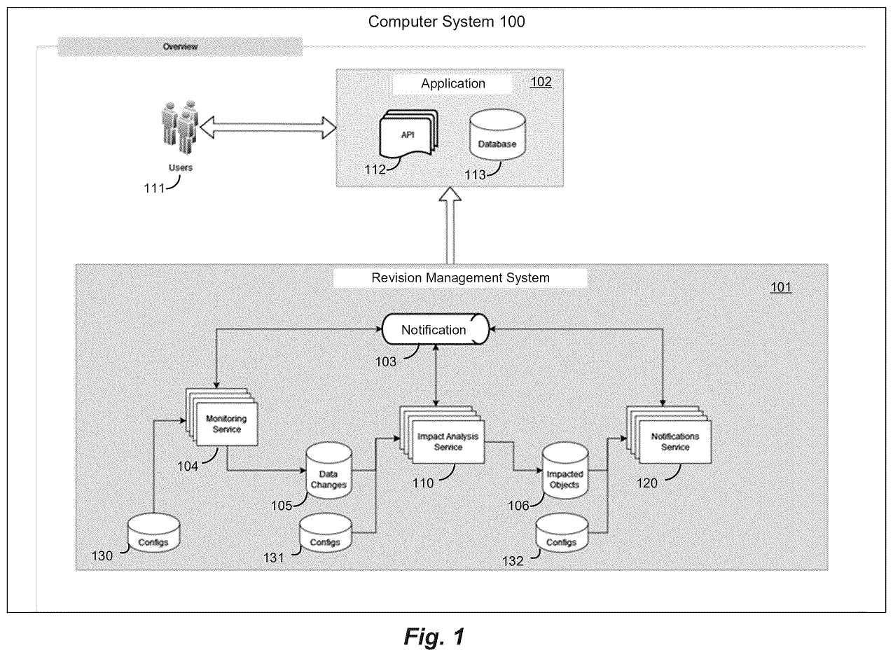

FIG. 1 illustrates an example revision management system 101 according to an embodiment. Features and advantages of the present disclosure include a revision management system 101 (also referred to herein as “change management”). Computer system 100 may include, for example, one or more computers comprising one or more processors and a computer readable medium (memory) for executing software to perform the techniques described herein. Here, embodiments of the present disclosure include techniques for monitoring revisions and generating aggregated notifications, for example. The diagram visually represents the flow from monitoring database changes to delivering notifications to users. It illustrates major services, showing their roles and interactions.

The diagram provides an overview of the revisions management system 101 and its integration with a software application module 102 (here, the Workpacks module). Application 102 may allow users 111 (e.g., of other software systems) to interact with data in database 113 using an interface (e.g., APIs 112). User interactions with data may result in changes in the data that impact various objects in the system as well as the workflows of other users, for example. The example revision management system 101 comprises several main services that work together to monitor database changes, analyze their impacts, and notify users accordingly. These services are integrated through a notification system 103 (e.g., Apache Kafka), which facilitates communication between them and allows for seamless integration with external systems.

### Summary of Main Services

Monitoring Service 104: Captures and records database changes in real-time by creating dynamic triggers based on system configurations. Monitoring service 104 may be configured using configuration data 130 and produces an output indicating changes to the data at 105 as described in more detail below.

Impact Analysis Service 110: Processes the captured changes to identify and store information about impacted objects as impact object records, for example, using business logic stored in the system's configurations. Impact analysis service 110 may be configured using configuration data 131. Impact analysis service 110 receives the captured data changes 105 and outputs impacted object records 106 based on configuration data 131 as described in more detail below.

Notifications Service 120: Generates and delivers notifications based on the impacted object records, ensuring that relevant updates are communicated effectively. Notification service 120 may be configured using configuration data 132. Notification service 120 receives the impacted object records 106 and outputs notifications based on configuration data 132 as described in more detail below.

Configs 130-132: Stores and manages the configurations for each service, enabling the system to automatically adapt to configuration changes in real-time.

Notification (Kafka) 103: Serves as the communication backbone between the services and provides integration capabilities with external systems.

### 1. Dynamic Monitoring Service

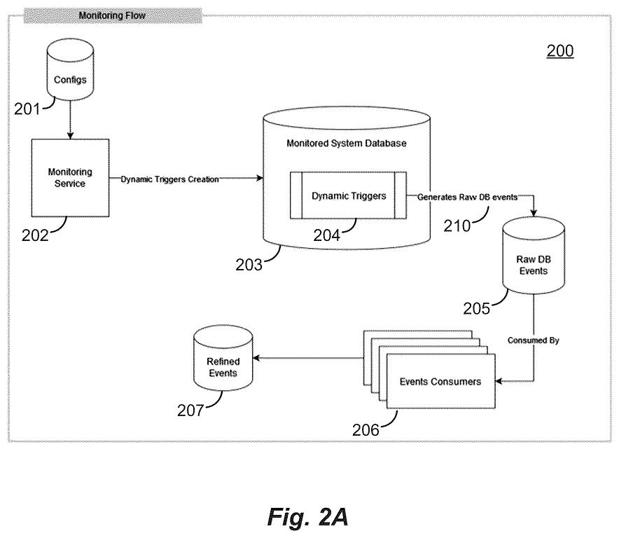

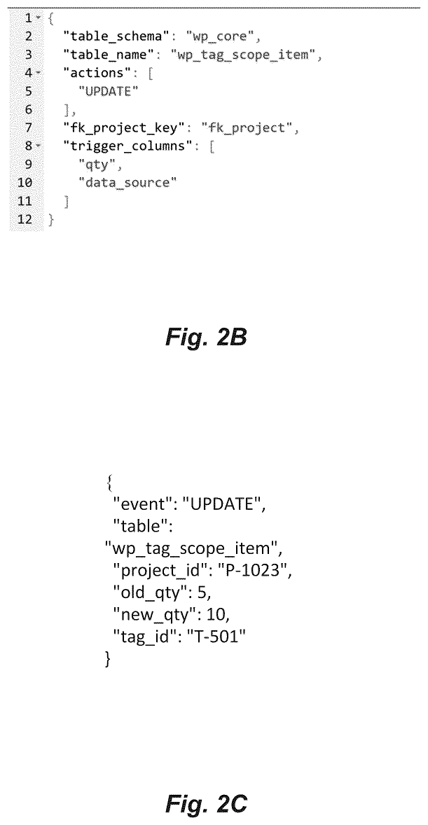

FIG. 2A illustrates example monitoring according to an embodiment. The monitoring system 200 may be designed through a dynamic service that configures and deploys database triggers in real-time to track specific table events. Unlike traditional systems that rely on a single node for logical replication-prone to bottlenecks and single points of failure—some embodiments of the present system's architecture may distribute the monitoring load by creating a temporary table that captures raw change events. These events are then refined according to customizable configurations, enabling selective monitoring that aligns precisely with system requirements. This innovative approach not only mitigates the risk of failures by allowing multiple consumers to process refined events but also introduces flexibility and scalability, empowering the system to adapt seamlessly to varying workloads and operational demands.

### Monitoring Flow Explanation

### Configuration Setup

The process begins with the Configuration Service, where specific configurations (i.e., configuration data) are defined. The configuration data 201 (i.e., monitoring configuration data) may dictate which database tables and events are to be monitored by the system. In one embodiment, configuration data 201 may specify a table, an action being monitored, and particular columns that trigger an output, for example, as illustrated in an example below where the configuration data is represented in JSON.

### Dynamic Triggers Creation

The Monitoring Service 202 leverages the configurations 201 to dynamically create triggers 204 within the Monitored System Database 203. These triggers 204 are tailored to listen for specific database operations (aka, database events) on the monitored database tables (e.g., insertions, deletions, updates).

For example, triggers may be created based on the configuration data 201. Triggers are responsible for capturing raw events and logging them in a designated changes table. As but one example, if a user wants to monitor a table “wp_core.wp_tag_scope_item” for updates to a “qty” column. The configuration (201 in FIG. 2B) may include JSON indicating:
table: “wp_core.wp_tag_scope_item” //table to be monitored
actions: [“UPDATE”] //event to be monitored
trigger_columns: [“qty”] //column to be monitored

The monitoring service parses the configuration data (e.g., the JSON above) and creates a dynamic SQL trigger as follows:

‘‘‘sql
CREATE TRIGGER trg_wp_qty_update
AFTER UPDATE OF qty ON wp_core.wp_tag_scope_item
FOR EACH ROW
WHEN (OLD.qty IS DISTINCT FROM NEW.qty)
EXECUTE FUNCTION log_change_event( );
‘‘‘

### Event Generation

Once the triggers are set, the Monitored System Database 203 generates Raw Database Events 210 in real time. These events represent the changes occurring in the database tables as specified by the configurations. Events 210 may be stored in a storage system 205. For example, the SQL trigger in the above example may be stored in the monitored database schema and calls ‘log_change_event( )’ when qty changes. The ‘log_change_event( )’ function writes to a “changes” table with old/new values and timestamps. A separate service listens for inserts to this table and pushes them as raw events into the system's streaming layer for downstream processing.

### Event Consumption

The Raw Database Events are then consumed by one or more Events Consumers 206. In some embodiments, parallel consumption allows for scalability, where multiple consumers can process different sets of events simultaneously, thereby avoiding bottlenecks or a single point of failure. The following are two examples of event consumers. The event consumers convert low-level data changes into contextualized events that improve the analysis of events by the system for example.

### Example 1: JSON Event Logger

Consumes raw events from PostgreSQL NOTIFY mechanism via pg_notify.
Reads inserted rows from the changes table.
Parses the row content into structured JSON (refined event).
Adds metadata (e.g., project_id, timestamp) before passing the refined event downstream.

### Example 2: Kafka Consumer Microservice

Subscribes to a Kafka topic called “raw-db-events”.
Validates and enriches raw event (e.g., mapping foreign keys to human-readable names).
Writes the refined event to a “refined_events” table for use by the impact analysis engine.

### Event Refinement

After consumption, the raw events are processed and refined into a more structured and meaningful format. This refined data is stored in a storage 207 as Refined Events, which can be further utilized by other services or layers within the system.

### Key Features

Scalability: The architecture allows for multiple event consumers, making the system scalable and capable of handling large volumes of data changes.

Dynamic Monitoring: The monitoring service 202 is adaptive and configurable, enabling dynamic creation of triggers based on real-time needs and configurations.

Fault Tolerance: By avoiding a single point of failure (e.g., unlike traditional logical replication systems), this monitoring flow is designed to be resilient and reliable, ensuring continuous monitoring without disruptions.

### Example Use Cases and Configuration

The dynamic monitoring system is versatile and can be configured to monitor diverse data changes. Two practical use cases include document revision tracking and inventory quantity monitoring for tagged items, both critical in large-scale construction projects.

### Example Use Case 1: Document Revisions Tracking—Foundation Pouring Records

In a large-scale commercial construction project, foundation pouring is conducted in multiple stages. Each stage requires updated engineering documents, including structural drawings, safety protocols, and inspection logs, all of which must align with the latest site conditions and construction modifications.

During the foundation pouring process, unexpected soil inconsistencies necessitated adjustments to the original foundation depth. This led to an immediate update in structural plans, safety measures, and inspection requirements. Initially issued as “Foundation Drawing Rev1,” the document was soon revised to “Foundation Drawing Rev2” with updated depth and rebar placement specifications.

Through the dynamic monitoring system, document updates were tracked in real-time. This ensured that each on-site supervisor received immediate notifications of new versions, helping the teams work from the most current and accurate specifications. Additionally, quality assurance protocols in the system flagged any reports or issues linked to previous versions, helping prevent non-compliance and maintain safety standards. Document revision tracking through thus helped mitigate potential delays and ensure seamless communication across teams, critical for regulatory compliance and project success.

### Example Use Case 2: Inventory Quantity Monitoring for Tags—Pipeline Welding and Installation

In a refinery construction project, precise monitoring of tagged pipeline spools is essential, as each spool has unique attributes such as material type, diameter, and length. These attributes are tracked through a tagging system, allowing for real-time inventory management to meet the project's evolving requirements.

During the pipeline welding phase, design modifications to accommodate equipment layout changes required adjustments to certain tagged pipe spools. Specifically, several spools tagged as P-16-SS needed length extensions to bridge newly expanded areas, while other spools required a change in material type from carbon steel to stainless steel to withstand higher temperatures in modified sections. Additionally, a subset of spools needed a diameter adjustment to meet updated flow specifications.

To capture these changes, the inventory list was revised from “Pipe Inventory List Rev1” to “Pipe Inventory List Rev2.” Using the dynamic monitoring system, project managers could track these spool adjustments in real-time, ensuring that only spools meeting the revised specifications were delivered to the site. Each change was captured under the relevant tags, providing updated length, material, and diameter attributes to facilitate compliance with the modified design.

With immediate visibility into inventory adjustments, the system minimized the risk of misallocated materials or delays. Welders and installers were notified about the updated spools through the tracking system, enabling them to access accurate information about spool specifications. The integration of this dynamic monitoring system provided quality assurance by verifying spool modifications, which were documented for regulatory compliance and warranty tracking. This streamlined process helped keep the project on schedule, ensuring that construction proceeded efficiently and in line with evolving requirements.

### Technical Overview of use Cases

Document Revisions Tracking: Monitoring document updates and changes, enabling tracking of version history and modifications.

Inventory Quantity Monitoring for Tags: Observing quantity changes in tagged items.

Each use case may be configured through a JSON schema, where attributes specify monitoring actions, target columns, and filter criteria. FIG. 2B illustrates an example JSON configuration specifying what is to be monitored, including an explanation of each attribute.

### Attribute Descriptions

table_schema, table_name: Specifies the name of the target database table. In this example, “wp_core.wp_tag_scope_item” refers to the table containing data about specific tags under monitoring.
actions: An array defining the type(s) of database actions (e.g., “UPDATE”, “INSERT”, “DELETE”) that should trigger the monitoring service.

fk_project_key: This field defines the foreign key associated with a specific project, allowing the monitoring service to filter and relate changes to a particular project scope.
trigger_columns: Identifies the specific columns that trigger the monitoring process when changes are detected. A revision event is initiated only when one of these columns—such as “qty” or “data_source”—is modified. This approach optimizes processing by focusing the trigger on key data points while still capturing the full context of each entry.

### Example of an Insert Database Raw Event

FIG. 2C illustrates a JSON object showing a sample raw database (db) event captured by the monitoring system. FIG. 2C illustrates an example detected change using the monitoring JSON of FIG. 2B. This event captures all relevant data for the newly inserted entry, allowing for thorough data tracking and integration with other system components. The JSON in FIG. 2C is the example raw event which may be transformed into a refined event with standard fields, timestamps, and structured payload, for example.

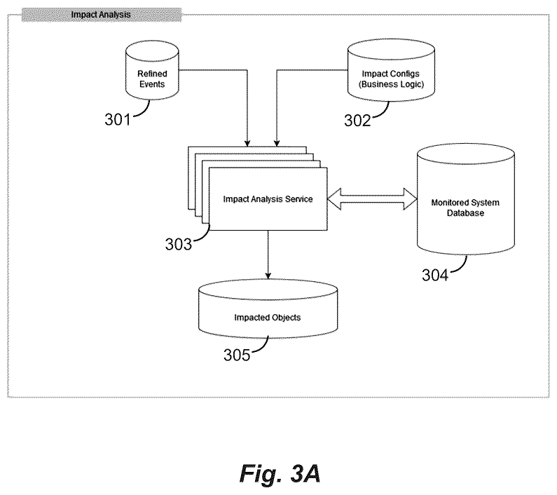

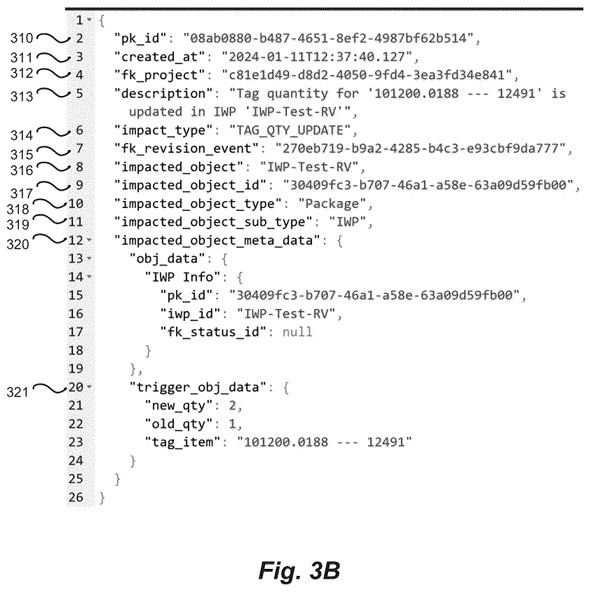

FIG. 3A illustrates example impact analysis according to an embodiment. This diagram illustrates the Impact Analysis flow within a system that processes refined events to determine their effects on the system's objects.

### 2. Adaptive Impact Analysis Layer

Embodiments of an adaptive impact analysis layer may bridge the gap between raw data changes and business-critical decisions, for example. The impact analysis layer may apply custom analysis logic to the refined events, generating a detailed list of impacted object records within the monitored environment. By functioning as an abstraction layer, for example, using software code and algorithms to produce a simplified view to users or other software components, impact analysis layer may decouple the core data processing from the specific business logic, allowing for highly customizable responses to database changes with minimal reconfiguration. Some embodiments of the present architecture not only enhance the system's adaptability to diverse business needs, but may further ensure that the impact analysis remains precise, context-aware, and aligned with evolving operational requirement, for example.

### Example Impact Analysis Flow Explanation

### Input Sources

Refined Events 301: These may be the events that have been processed and structured by the system after being captured by the monitoring service, for example. Events contain specific data changes that occurred in the monitored system.

Impact Configurations (Business Logic) 302: Impact configuration data defines the business logic that dictates how different events should be analyzed. This includes rules and conditions for determining the potential impact of each event on various system objects.

### Impact Analysis Service 303

The Impact Analysis Service 303 is the core component that processes the refined events in conjunction with the impact configurations. It evaluates the incoming refined events against the predefined business logic to assess how these events impact the monitored system's objects.

The service interacts with the Monitored System Database 304 to fetch additional data, if necessary, ensuring that the analysis is comprehensive and considers all relevant factors.

### Impact Output

After processing the refined events, the Impact Analysis Service 303 may generate a list of impacted objects. These are the system objects that are affected by the events and may require further action or notification.

The impacted object records are stored in a dedicated repository 305, where they can be accessed by other services for further processing, such as generating notifications or triggering additional workflows.

### Features of Some Example Embodiments

Customization and Flexibility: The use of impact configurations 302 allows for customizable business logic that can be tailored to different use cases, making the system highly adaptable to various industries or specific business needs.

Integration with Database: The service's ability to interact with the monitored system database ensures that the impact analysis is accurate and data-driven, taking into account real-time system states.

Comprehensive Impact Assessment: By combining refined events with specific business logic, the impact analysis service provides a thorough evaluation of how changes in the system affect its components, enabling proactive management and response.

### Example of Impacted Object Records From the Database

FIG. 3B is an example JSON impacted object record generated by the Impact Analysis Service, which reflects an update in the tag quantity of a monitored item. Generally, a system object is the canonical entity that resides in the monitored application database (e.g., a Tag record, IWP record, or Document record). System objects may form the source-of-truth for operational data. Impacted object records, an example of which is shown in FIG. 3B, may be generated by the Impact Analysis Service and stored in a separate impacted objects repository 305, for example. An impacted object record may reference one or more system objects and includes enriched contextual data: identifiers, revision event references, trigger values (old/new), computed values such as deltas or percentages, an impact classification, routing/notification metadata, and other supplemental information fetched at runtime. In the present example embodiment, system objects are not overwritten or directly modified by the impact data. The canonical record remains intact in the monitored database. In this example, the Impact Analysis Service generates an impacted object record as a separate, non-destructive artifact. This advantageously enables notification, aggregation, and auditing without disturbing the operational dataset.

This example illustrates how the system stores contextual information about the impacted object in the impact object record, enabling subsequent data processing and response actions. The example impacted object record in FIG. 3B includes an identification (ID) 310, creation time stamp 311, associated project 312, description 313, impact type 314, associated revision event 315, and impacted object name 316, ID 317, type 318, subtype 319, and metadata 320 (e.g., pk_id, iwp_id, and fk_status_id). Further, this example includes trigger object data 321 320 (e.g., new quantity, old quantity, and tag_item). Advantageously, in this example, the impact type 314 may define the type of change that occurred (e.g., “TAG_QTY_UPDATE”=tag quantity change), the object id 317 and object type 318 may uniquely identify the object affected (e.g., a specific item or tag), trigger data 321 may comprise before and after values (e.g., qty_old vs qty_new), which support comparison and action, and project id (“pk_id”) may enable the system to relate the impact to a particular project scope, for example. These fields collectively enable filtering, routing, and rule-based response.

The following example further illustrates the features and advantages of some embodiments.

### Example Refined Event

```
‘‘‘json
{
  ″event_type″: ″UPDATE″,
  ″table″: ″wp_tag_scope_item″,
  ″tag_id″: ″T-501″,
  ″old_qty″: 5,
  ″new_qty″: 10
}
‘‘‘
```

### Example Impact Configuration Data

```
‘‘‘json
{
  ″table″: ″wp_tag_scope_item″,
  ″column″: ″qty″,
  ″impact_type″: ″Tag Quantity Change″,
  ″notify_role″: ″Workface Planner″
}
‘‘‘
```

In this example, the impact configuration data specifies a table, column in the table, an impact type, and specifies the role of users to be notified (i.e., notify role). The above example refined event and impact configuration data may be combined by impact analysis service 303 to extract data about the impact from the database and produce the following example impacted object record:

```
    ‘‘‘json
{
  ″object_id″: ″IWP-453″,
  ″impacted_tag″: ″T-501″,
  ″change_type″: ″Quantity Increase″,
  ″delta″: 5,
  ″affected_role″: ″Workface Planner″
}
‘‘‘
```

The impacted object record in the above example includes an object identification (id), an impacted tag, a change type, an amount of change (i.e., delta), and a role of an affected user (i.e., affected role or “affected_role”).

The following example illustrates another configuration, event, and output of the impact analysis service for a document status change:

### Configuration

monitor wp_documents.status; if OLD.status≠NEW.status, generate a “DOCUMENT_STATUS_CHANGE” impact and notify the QA/QC role.

### Event

Document DOC-900 changes from Draft to Approved.

Output: The Impact Analysis Service generates an impacted object record with:
impact_type=“DOCUMENT_STATUS_CHANGE”
metadata={old_status: Draft, new_status: Approved, modified_by: user_123}
affected_roles=[QA/QC]

This record is stored in the impacted objects repository 305 and used to drive notifications/aggregations. The original document row in the monitored DB may remain unchanged.

The following example illustrates another configuration, event, and output of the impact analysis service for a Tag quantity change with equation (e.g., with the configuration data 302 storing user defined equations):

### Configuration

logic: delta=NEW.qty−OLD.qty;
   percent=(OLD.qty==0)? 100: (delta/OLD.qty)*100;
   impact_type=(abs(percent)>20)? “TAG_QTY_CHANGE_MAJOR”: “TAG_QTY_CHANGE_MINOR”;
   notify_roles=(abs(percent)>20)?
[“ConstructionManager”,“WorkfacePlanner”]: [“WorkfacePlanner”];

Event: Tag T-501 quantity changes from 5→10.
Evaluation: delta=5, percent=100%, impact_type=TAG_QTY_CHANGE_MAJOR, notify_roles=[ConstructionManager, WorkfacePlanner].

Output: An impacted object record is generated that references Tag T-501, includes the computed delta and percent fields, classifies the impact as major, and routes to the correct roles.

As illustrated above, impact configuration data may store equations or logical expressions. These are evaluated by the Impact Analysis Service at runtime to compute values (e.g., deltas, percentages, or thresholds) and to classify the resulting impact. Embodiments using this example approach support flexible, rule-driven enrichment of impacted object records while leaving canonical system objects unchanged unless an explicit downstream rule dictates otherwise.

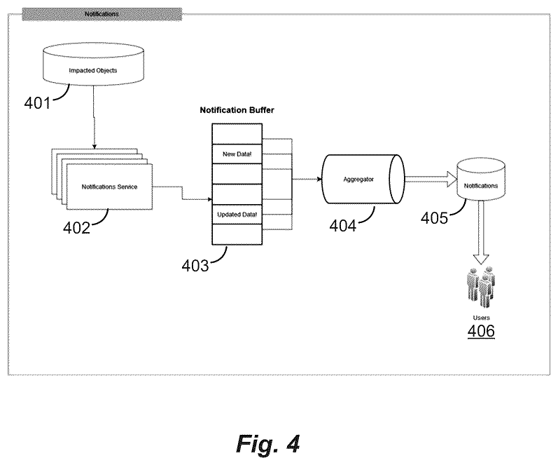

FIG. 4 illustrates example notification according to an embodiment. This diagram provides a visual representation of the Notification Service and its role in delivering notifications to users based on impacted object records identified by the system.

### 3. Intelligent Notification Aggregator

Recognizing the potential for overwhelming volumes of notifications, especially in complex environments like Advanced Work Packaging (AWP) in construction, some embodiments incorporate an intelligent notification buffer and aggregator. This sophisticated mechanism processes impacted object records, consolidating them into concise, actionable notifications tailored to the user's needs or roles within the organization. By aggregating notifications, the system ensures that users receive relevant information without the clutter of excessive data, thereby enhancing decision-making efficiency. This innovative approach to notification management transforms potentially chaotic change data into clear, manageable insights that drive productivity and responsiveness.

### Notification Service Flow Explanation

### Input Source—Impacted Object Records 401

In this example, the process begins with impacted object records 401, which have been identified by the Impact Analysis Service, for example, as being affected by certain events or changes within the system. These impacted object records may comprise important pieces of information to be communicated to the end-users.

### Notifications Service 402

The Notifications Service 402 is responsible for processing the impacted object records and preparing them for delivery to the users. This service converts the impacted object records into actionable notifications, ensuring that the information is structured in a way that is meaningful and relevant to the users. Notification service 402 may extract data from the impacted object record and form a test string, for example. The following is an example conversion of an impacted object record into a notification.

### Impacted Object Record

```
‘‘‘json
{
  ″object″: ″T-501″,
  ″impact″: ″Tag Quantity Increase″,
  ″delta″: 5,
  ″action″: ″Notify Planner″
}
‘‘‘
```

Resulting Notification: “Qty change for Tag T-501 from 5 to 10.”

The service pushes these notifications into the Notification Buffer 403 for further processing.

In some embodiments, notification service 402 may comprise notification rules. Example rules may include, for example, the following:
1. If qty increases by more than 20%, escalate to construction manager.
2. If document revision increases and status is “Approved for Construction,” notify QA/QC team.
3. If material type changes (e.g., carbon steel→stainless steel), flag for engineering review.

### Notification Buffer 403

The Notification Buffer 403 acts as an intermediary storage area that holds the notifications before they are sent out to the users. The buffer ensures that all notifications are queued and ready for aggregation, preventing any loss of information.

### Aggregator 404

The Aggregator 404 is an innovative component that processes the buffered notifications. It takes the raw notifications data and combines them into compact, concise notifications that are more digestible and useful for the users. For example, aggregator 404 may determine if a plurality of impacted object records correspond to the same object (e.g., the same project or subproject or work package) and generated a combined text string based on the related text strings. In some embodiments, related text strings may be excluded from combination based on one or more fields (e.g., related notifications with different roles (e.g., procurement vs. planner) or unrelated scopes or notification thresholds being below a threshold).

This step may be particularly important in scenarios like Advanced Work Packaging (AWP), where changes might affect many objects, and sending a single, comprehensive notification is more effective than bombarding the user with numerous individual alerts, for example.

### Output—Notifications 405

After aggregation, the finalized notifications are stored in the Notifications repository, ready to be delivered to the end-users. These notifications are then sent to the Users 406, ensuring they are informed about the relevant changes and can take any necessary actions.

Possible Actions Based on Impacted Object Records: The system may provide several actions that can be taken in response to the impacted object records:

Sending Notifications: Users can be notified about updates related to specific work packages.

Sending Emails: Automated email alerts can be dispatched to relevant personnels.

Creating Actions: Actions can be initiated within the system to create or update work packages based on the changes detected.

Data Manipulation in the Monitored Database: Direct modifications can be made to the monitored database as required.

### Key Features

Efficient Notification Management: The buffer and aggregator together ensure that notifications are handled efficiently, reducing the risk of overwhelming users with excessive information and ensuring that only the most relevant and compact notifications are delivered.

Scalability: The system is designed to handle large volumes of notifications, making it suitable for complex environments like AWP, where changes can impact numerous objects simultaneously.

User-Centric Delivery: By aggregating and refining notifications, the system ensures that users receive clear, actionable insights rather than raw, unfiltered data, improving decision-making and response times.

### 4. Seamless Integration Capability

The present example system is designed for integration flexibility and enabling seamless connectivity with external services. Each service within the system is equipped to emit service-specific data events that can be easily consumed by third-party applications, facilitating effortless integration into broader IT ecosystems. This design not only amplifies the system's scalability and customization potential but also ensures that it can evolve alongside organizational needs, offering a foundation for ongoing innovation and expansion. The ease of integration transforms this system into a versatile hub of revision management, adaptable to a wide range of operational contexts.

### 5. Self-Monitoring Configuration Management

Some embodiments of the present system may feature a self-monitoring configuration management process where it leverages its own monitoring capabilities to ensure real-time configurations updates across all service layers. Configurations for each service layer are stored in a centralized database, and the system itself continuously monitors these configurations internally. When changes to configurations are detected, the system automatically updates the relevant services in real-time, ensuring seamless and immediate adaptation to new settings. This self-monitoring capability ensures that all services remain synchronized with the latest configurations, enhancing operational efficiency and reducing downtime typically associated with manual updates. By automating the configuration management process, the system achieves a higher degree of responsiveness and adaptability to changing requirements.

As but one example, suppose a procurement engineer adjusts a bill of materials (BOM) for an IWP by removing 3 items and adding 2 new materials. The system triggers the following:
Monitoring: captures these updates.
Impact Analysis: determines IWP-501 is affected.
Notifications: one notification with a summary: “IWP-501 has 2 added materials and 3 removed. Click here to review.”

This notification may be displayed in an IWP dashboard, for example, and optionally emailed.

### Services Overview

### A. Example Monitoring Service

Purpose: Automatically creates triggers for database tables to catch up and log every change operation, it will create and track versioning of change data depend on operation made
Features:
   Dynamically creates triggers.
   Logs changes in the change monitor table.
   Notifies streaming service using predefined notify mechanic.

Additional monitoring service features may include the following:

Trigger Creation: Dynamically create database triggers using the configuration in config table, those triggers will help to auto monitor changed data in the target table for further processing.

Change Logging: whenever there is any changed data in target monitoring table, trigger will auto log those change into changes table, in this table we have key reference to the monitored table, also the old/new data of changed records, with that we can make versioning of changed data (Refined events).

Notification: after having data in changes table, pg_notify plugin will auto collect and send message to messaging service for other service to process.

### B. Example Impact Analysis Service

Purpose: Analyzes the impact of changes and logs affected data.
Features:
   Listens to streaming events.
   Logs impacted data in the impacted table.
   Notifies streaming service after impact analysis for further processing.

Notifications Service:
Purpose: Generates notifications based on impacted data.
Features:
   Monitors streaming service for new messages (impacted data...etc.).
   Create appropriate notification based on predefined config.
   Store those notifications in a predefined table for further processing.

Additional monitoring service features may include the following:

Event Listening: Listen to notification events generated by monitoring service.

Impact Analysis: Analyze data changes in changes table based on predefined config rules.

Impacted Data Logging: Log impacted data in impacted objects table.

Notification: After having data in impacted objects table, pg_notify plugin will auto collect and send message to messaging service for other service to process.

### C. Example Notifications Aggregator Service

Purpose: consume and buffer send notifications
Features:
   Monitors streaming service for new messages (notification message).
   Create appropriate notification based on predefined config.
   Send notification to appropriate channels

Additional notification service features may include the following:

Event Listening: Listen to notification events generated by Impact analysis service.

Notification Generation: Generate notifications based on predefined rules. Store notifications into buffer table for other service to collect and send.

Notification: After having data in buffer table, pg_notify will auto collect and send message to messaging service for other service to process.

Additional notification aggregator service features may include the following:

Event Listening: Listen to notification events generated by notification service.

Notification aggregator: Collect notifications from buffer and generate batch of aggregated notifications.

Notification processing: Send batch notification to appropriate channel (email, user . . . etc.)

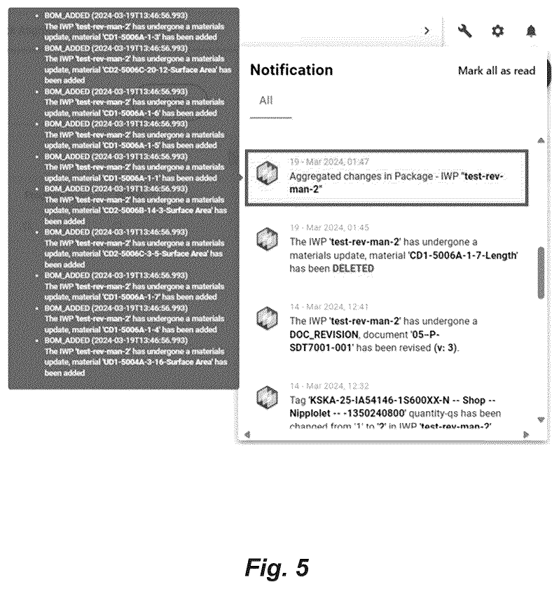

FIG. 5 illustrates an example user interface for aggregated notifications according to an embodiment.

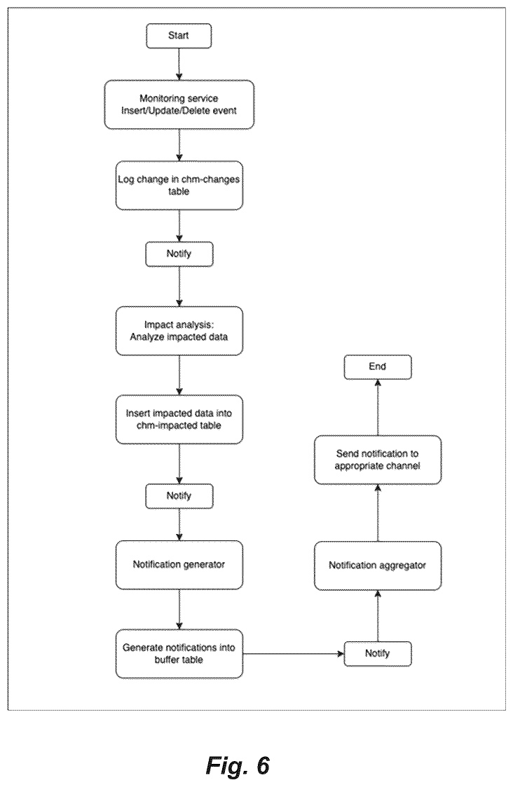

FIG. 6 illustrates an example process flow according to an embodiment.

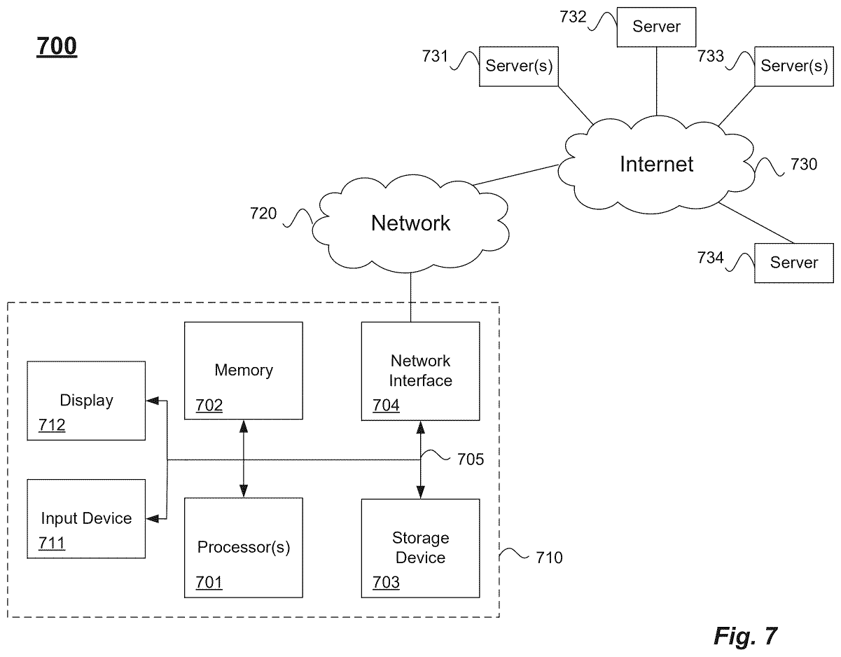

FIG. 7 illustrates hardware of a general purpose computing system 700 configured according to the above disclosure. The following hardware description is merely one example. It is to be understood that a variety of computers topologies may be used to implement the above-described techniques. An example computer system 710 is illustrated in FIG. 7. Computer system 710 includes a bus 705 or other communication mechanism for communicating information, and one or more processor(s) 701 coupled with bus 705 for processing information. Computer system 710 also includes memory 702 coupled to bus 705 for storing information and instructions to be executed by processor 701, including information and instructions for performing some of the techniques described above, for example. Memory 702 may also be used for storing programs executed by processor(s) 701. Possible implementations of memory 702 may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 703 may include source code, binary code, or software files for performing the techniques above, for example. Storage device 703 and memory 702 are both examples of non-transitory computer readable storage mediums (aka, storage media).

In some systems, computer system 710 may be coupled via bus 705 to a display 712 for displaying information to a computer user. An input device 711 such as a keyboard, touchscreen, and/or mouse is coupled to bus 705 for communicating information and command selections from the user to processor 701. The combination of these components allows the user to communicate with the system. In some systems, bus 705 represents multiple specialized buses for coupling various components of the computer together, for example.

Computer system 710 also includes a network interface 704 coupled with bus 705. Network interface 704 may provide two-way data communication between computer system 710 and a local network 720. Network 720 may represent one or multiple networking technologies, such as Ethernet, local wireless networks (e.g., WiFi), or cellular networks, for example. The network interface 704 may be a wireless or wired connection, for example. Computer system 710 can send and receive information through the network interface 704 across a wired or wireless local area network, an Intranet, or a cellular network to the Internet 730, for example. In some embodiments, a frontend (e.g., a browser), for example, may access data and features on backend software systems that may reside on multiple different hardware servers on-prem 731 or across the network 730 (e.g., an Extranet or the Internet) on servers 732-734. One or more of servers 732-734 may also reside in a cloud computing environment, for example.

### Example Construction Application

Construction projects frequently entail numerous stakeholders and regular revisions to scope and documents. Traditional revision management methods may prove insufficient in meeting the unique demands and complexities of the construction industry, relying on manual updates to logs by quantity surveyors and document management teams. This manual approach necessitates additional workforce, heightened efforts, and significantly increases the risk of human error. Thus, there is a clear necessity for an enhanced system and method for effectively managing revisions in construction projects.

The present disclosure introduces an innovative approach to managing revisions in construction projects, specifically tailored for advanced work packaging environments. With the aim of effectively tracking, monitoring, notifying, and reporting changes within such environments, the system offers seamless integration with pre-existing modules. This flexible integration enables smooth configurations within the document management module, as well as material and tag management functionalities. These integrated features facilitate a comprehensive and streamlined revision management process, triggering a full-fledged transformation in how revisions are handled within construction projects.

The system's capability to seamlessly integrate with existing applications ensures that project stakeholders can efficiently manage revisions while maintaining alignment with advanced work packaging principles. By enabling smooth configurations within the document management module, material, and tag management, the system enhances collaboration, efficiency, and accuracy throughout the project lifecycle. Moreover, the system's flexible integration empowers users to adapt to evolving project requirements and dynamic work environments, thereby promoting agility and responsiveness in revision management processes.

Furthermore, the system's advanced notification and reporting capabilities provide project stakeholders with real-time insights into changes, ensuring timely decision-making and proactive risk management. By offering comprehensive tracking, monitoring, and reporting functionalities, the system enables project teams to maintain visibility and control over revisions, ultimately leading to improved project outcomes and enhanced stakeholder satisfaction.

In summary, various embodiments of an innovative system presented herein represents a significant advancement in revision management methodologies for construction projects, particularly within advanced work packaging environments. Through its seamless integration with other existing applications, and robust feature set, the system empowers project stakeholders to effectively manage revisions, minimize errors, and optimize project performance.

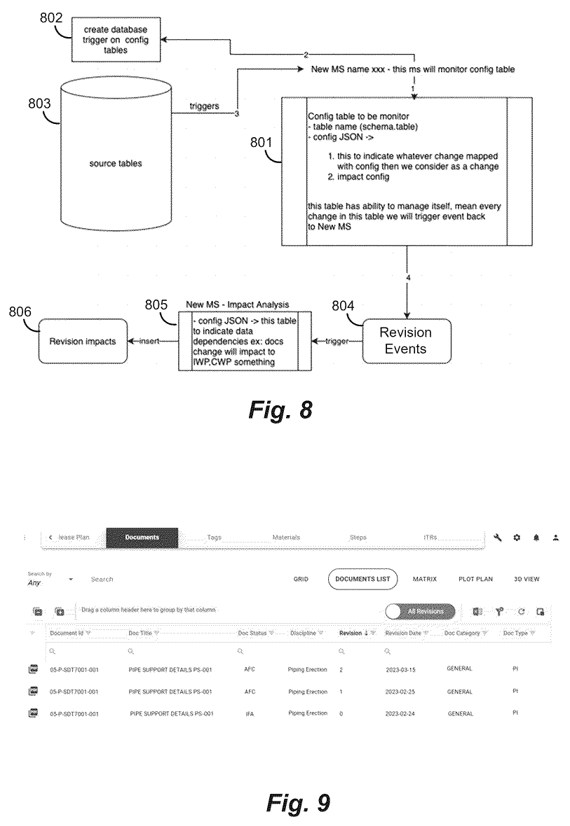

FIG. 8 is another example of a system for revision triggers and configurations around a database structure.

The example revision management system described herein offers a comprehensive suite of features designed to address the intricate needs of construction projects, particularly concerning drawing/document revision, tag update, tag quantity, and material update. These features collectively contribute to streamlining the revision management process, enhancing collaboration between stakeholders, and between different roles within the same stakeholder, depending on the pre-set configurable action of the notification mechanism.

### A. Drawing/Document Revision Management

One of the core functionalities of the system is its robust drawing and document revision capabilities. Users can seamlessly upload, view, and revise construction drawings, plans, specifications, and other relevant documents (e.g., within a centralized platform).

The system has all the workflows that integrate to any client's platform whether it is an outsourced document management module that a client uses, or an in-house platform. The system maintains a detailed revision history for each document and stores those in designated core product tables, allowing users to track changes, compare different revisions and notify users accordingly.

Similar to the system described in FIG. 2A, the example system of FIG. 8 store monitoring configuration information in a configuration table 801. Monitoring configuration information may include table names (schema. table), and a configuration JSON indicating a change mapped with a configuration setting and an impact. The configuration table may be self-managing, such that every change in the table will trigger an event back to a new microservice (MS). For example a monitoring service may listen for configuration table changes and re-generates triggers dynamically. This service enables self-monitoring, meaning it watches its own configuration and applies changes instantly without manual intervention. At 802 database triggers are created based on configuration information. At 803, source tables of a database may be subject to operations, some of which may invoke triggers based on the configuration information, for example. Triggers, in turn, cause the generation of revision events 804, which may trigger an impact analysis 805 (e.g., a change to a particular document will impact another object or process). At 806, revision impacts are generated as described above.

The document tracking module retrieves stored data pertaining to document revisions, including the document revision number and revision date.

FIG. 9 is a Snapshot of a user interface in a document module showing full track history of a single document. To track revisions on the document level, users can activate a toggle button to access the “Latest Revisions,” granting them visibility into the most recent versions of full documents stored in the software's core database as shown in FIG. 10, which shows a latest revision of the previously selected document in FIG. 9. The document revision tracking process may be addressed at an Integrated Work Package (IWP) level, ensuring that both the workface planner and IWP owner are promptly notified of any changes occurring at the document level.

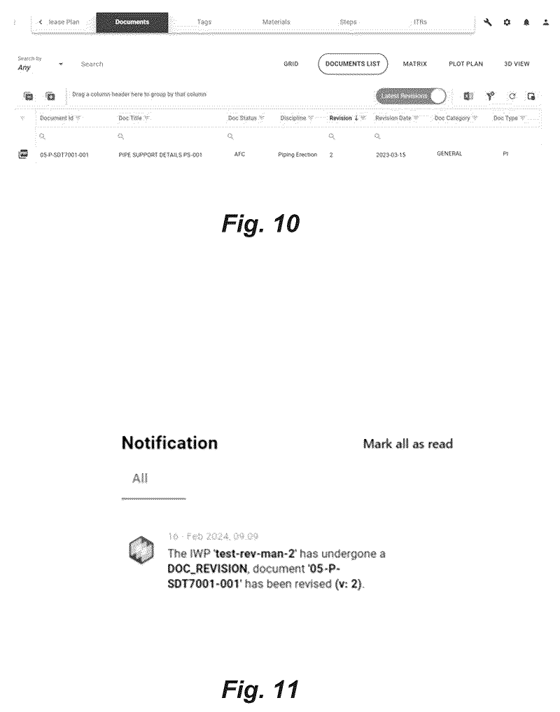

FIG. 11 shows a notification generated to the IWP owner/planner with the subject change at the document level. Notifications may also be sent via email, for example.

### Tag Revision Management

Before delving into tag revision management, the current tagging system within the software and what makes it a valuable aspect that needs to be maintained through revision management is described.

Tagging allows seamless organization and classification of data within the system platform, ensuring swift and effective retrieval and management of project scope. Embodiments of the system include an advanced tag management system configured to simplify the tagging process. Tags serve as dynamic metadata labels woven into the fabric of Construction Work Packages (CWPs) and Installation Work Packages (IWPs), offering a robust framework for project stakeholders to categorize, structure, and access work packages with unparalleled efficiency and precision. Tags serve as versatile signposts, guiding users through the labyrinth of project documentation and facilitating seamless navigation across diverse work packages. Whether categorizing CWPs based on project phase, geographical location, or technical discipline, or organizing IWPs according to installation sequence, resource requirements, or regulatory compliance, the tag management system empowers users with unparalleled flexibility and control over project organization.

Efficient data retrieval results in effective project management, and tagging capabilities optimize this aspect. By assigning relevant tags to CWPs and IWPs, users may access project information, eliminating the need for arduous manual searches and enabling swift access to pertinent data. Advanced search algorithms empower users to pinpoint specific work packages with surgical precision, streamlining decision-making processes and accelerating project timelines. Tags serve as catalysts for collaboration and knowledge sharing among project stakeholders. By fostering a common taxonomy and vocabulary, tags facilitate seamless communication and alignment across diverse teams and departments, promoting synergy and coherence throughout the project lifecycle. Furthermore, tag analytics capabilities provide invaluable insights into tag usage patterns, enabling stakeholders to glean actionable intelligence and optimize tagging strategies for enhanced project efficiency and performance.

### Tag Revision Management Ensuring Data Integrity and Collaboration

Traditional project management systems often struggle to maintain the coherence and accuracy of tagged data in the face of constant updates and revisions. The present system addresses this challenge by introducing a comprehensive tag revision management system that tracks changes, preserves historical data, and facilitates seamless collaboration among project stakeholders. This evolution represents a paradigm shift in project organization, empowering users with unparalleled control and visibility over tagged information.

The present example system fosters a collaboration of combined algorithms by enabling multiple data sources to contribute to tag management workflows seamlessly. Revision management provides a collaborative ecosystem allows diverse stakeholders, from project managers to field engineers, to contribute to tag management workflows effortlessly. The revision system's collaborative model lies its ability to harness the collective intelligence of disparate data sources. By aggregating data from various sources such as design documents, engineering specifications, and procurement databases, revision management system enriches tag management workflows with a wealth of contextual information. This multidimensional view enables stakeholders to make informed decisions, anticipate project risks, and optimize resource allocation with unprecedented accuracy and efficiency.

Moreover, the example revision management system's collaborative framework extends beyond internal stakeholders to encompass external systems of partners and vendors. By integrating external data sources such as supplier catalogs, regulatory databases, and industry standards repositories, the revision management system ensures that tag management workflows remain synchronized with external dependencies and compliance requirements. This seamless integration fosters collaboration across the project ecosystem, promoting transparency, accountability, and trust among all stakeholders.

Ensuring the accuracy and consistency of tagged data can be a daunting task, especially in large-scale projects with diverse stakeholders. Embodiments of the example system mitigate this challenge by implementing automated tag validation mechanisms that detect and rectify inconsistencies proactively. By enforcing predefined validation rules and data integrity checks, the system minimizes the risk of erroneous tags, enhancing the reliability and trustworthiness of project information.

Accordingly, tag revision management represents a paradigm shift in project organization and collaboration. By combining advanced revision tracking, collaborative workflows, automated validation, and insightful analytics, the present system ensures the integrity and reliability of tagged data, empowering users to navigate the complexities of project management with confidence and clarity.

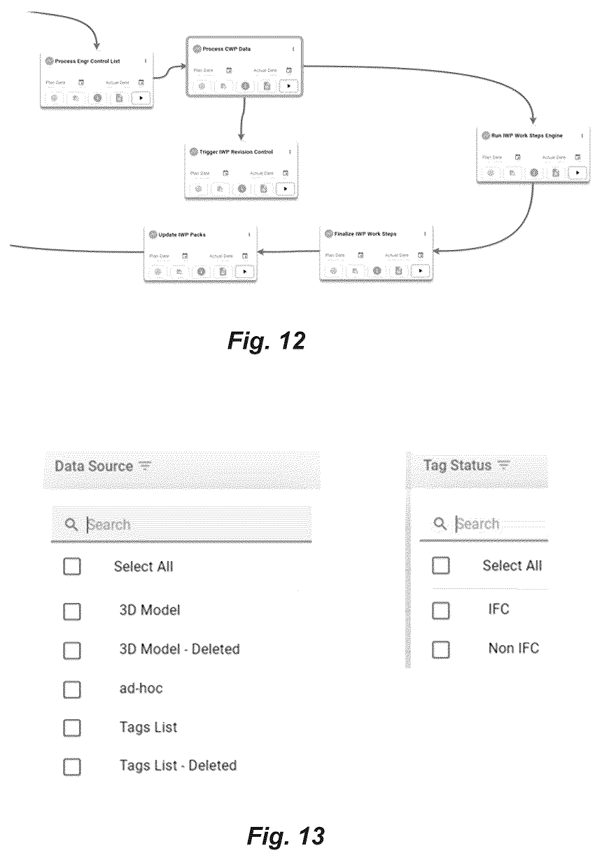

FIG. 12 illustrates a flow showing tag revision control as part of standard tag loading process

FIG. 13 illustrates a user interface for selecting different automated tag sources along with tag statuses that guarantee tag change control

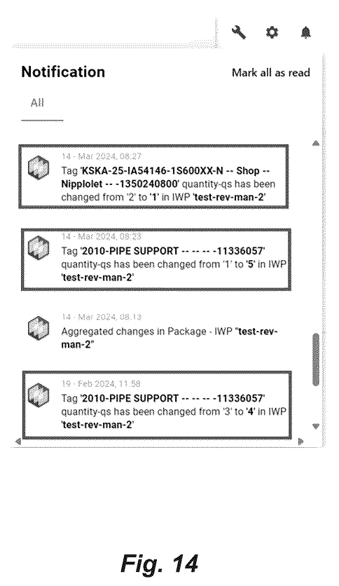

FIG. 14 illustrates a notification generated to the IWP owner/Workface planner with the tag quantity change (previous/current quantities are shown).

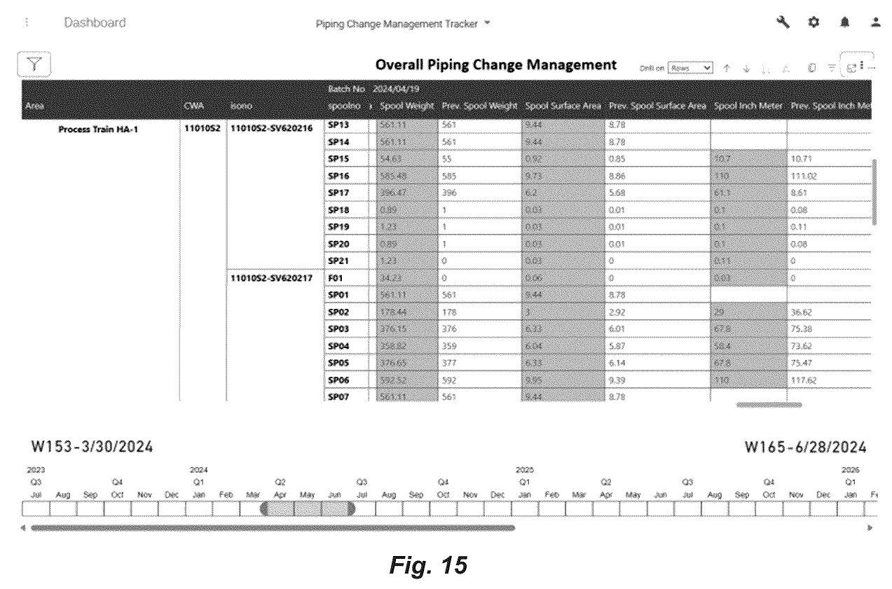

FIG. 15 illustrates a sample of piping change management tracker reports that tracks changes on pipe tag attributes like spool weight, surface area, size/length norms along with time window selection aligned with project calendar.

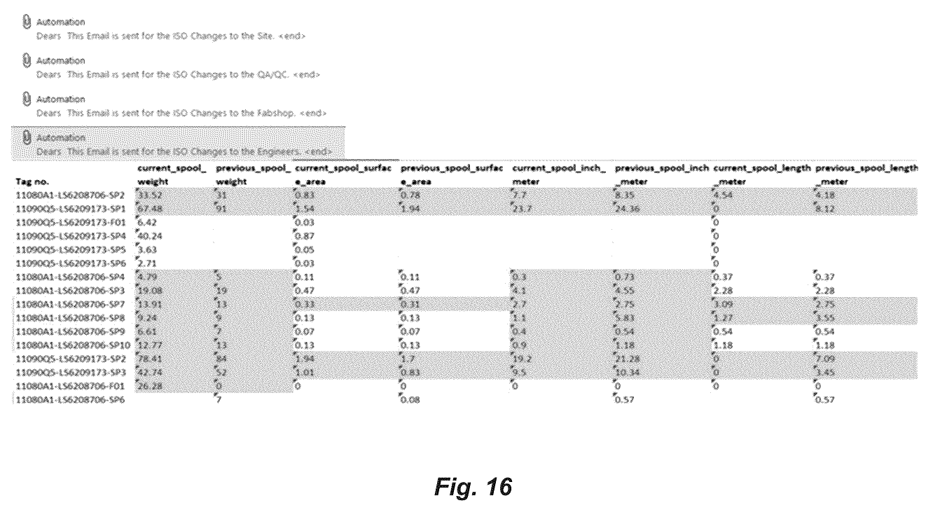

FIG. 16 illustrates automated aggregated notifications sent to construction departments for the current changes in tags based on tag status cycle under their custody.

These figures demonstrate a full methodology on the control process of detecting changes, storing changes, notifying changes, and confirming them by sending to direct owners.

Detecting Changes: This initial phase involves actively monitoring the system for any changes that occur. This could include changes in data, processes, configurations, or any other relevant aspect of the system. Detection methods may vary depending on the nature of the system, but typically involve automated monitoring tools, manual checks, or a combination of both.

Storing Changes: Once changes are detected, they may be recorded and stored in a structured manner. This ensures that a complete history of changes is maintained, which is advantageous for tracking and analyzing the evolution of the system over time. Storing changes can be done through various means, such as version control systems, databases, or dedicated change management tools.

Notifying Changes: Once changes are detected and stored, relevant stakeholders may be notified in a timely manner. Notification methods may include automated alerts, emails, dashboard updates, or other communication channels. One goal may be to ensure that stakeholders are aware of the changes that are occurring and can take appropriate action if necessary.

Confirming Changes: After being notified of changes, stakeholders may confirm and validate them. This may involve reviewing the details of the changes, assessing their impact on the system, and verifying that they were implemented correctly. Confirmation can be done through various means, such as manual reviews, automated tests, or user acceptance testing. Once changes are confirmed, they may be sent to the direct owners or responsible parties for further action. This ensures that the appropriate individuals or teams are aware of the changes and can take ownership of them going forward. Direct owners may include system administrators, project managers, department heads, or other relevant personnel.

### Material Revision Management

Another element in completing a project cycle is material revision management, with a specific focus on the procurement of materials allocated to installation work packages. This facet involves a methodical approach to tracking, documenting, and executing changes or updates to materials or components sourced for projects.

In some embodiments, material tracking is facilitated through unique material IDs, serving as identification codes or material codes that correspond to specific material components within designated projects or clients. Material data is typically inputted into the system through backend digital threads, which either integrate with the client's existing material system software or consume material lists directly. During the integration process, these material codes are linked with tags and 3D model components, ensuring that material components are appropriately packaged within installation work packages (IWPs) once the model components and tags are packaged.

Moreover, some embodiments of the system provide users with the flexibility to package material components either automatically through the integration process or manually using the quick assignment builder feature. This dual approach streamlines the packaging process, allowing users to efficiently allocate materials to IWPs based on project requirements and specifications.

Material revision management encompasses several types of changes tailored to adapt to evolving project needs. These include:
Adding Materials to IWPs: This revision involves incorporating new materials or components into existing installation work packages (IWPs). Such additions may stem from updated material lists resulting from changes in project specifications, design alterations, or the identification of additional requirements during project execution. Some embodiments facilitate this process by automating the process of allocating the new BOM (Bills of Materials) items to the designated work packages, or by providing users with tools to seamlessly input new material data, assign unique IDs, and associate them with the relevant IWPs.

Deleting Materials from IWPs: In certain instances, materials within IWPs may become redundant, obsolete, or no longer necessary for project completion. Deleting materials from IWPs streamlines inventory management and helps prevent unnecessary expenses. WorkPacks simplifies this process by automating deletion flags on BOM (Bills of Materials) items and by allowing users to identify and remove materials from IWPs using edit IWP component options in Builder, ensuring that associated procurement processes are updated accordingly.

Quantity Adjustments in IWPs: Quantity revisions entail modifying the quantities of existing BOM Ids within IWPs to align with revised project specifications or optimization objectives. These adjustments may result from changes in project scope, optimization efforts to reduce waste, or updates in material lists provided by the client and available a revision system. Some embodiments, through automated flows, enable users to seamlessly update material quantities within IWPs, ensuring accurate resource allocation and procurement planning.

Material Substitutions in IWPs: Sometimes, materials specified in IWPs may be substituted with alternative options due to availability constraints, cost considerations, or performance requirements. Material substitution revisions involve replacing specified materials with suitable alternatives while ensuring compliance with project specifications. Some embodiments may support material substitution by providing updated material lists in digital threads with time travels and time stamped versions, allocating the alternative BOM Id and descoping the un-necessary BOM (Bill of Materials) Id from the relevant IWP.

By accommodating these various types of material revisions within IWPs, some embodiments empower project teams to efficiently adapt to changing project requirements, optimize procurement processes, and ensure the effective management of material resources throughout the project lifecycle.

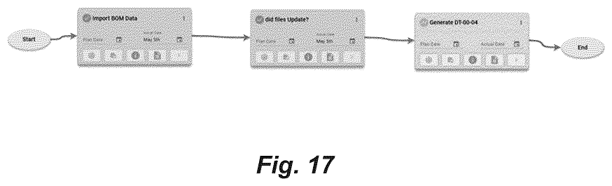

FIG. 17 illustrates a BOM revision flow storing data to digital threads with time stamps.

### Further Examples

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

Example 1. In one embodiment, the present disclosure includes a computer implemented method comprising: storing configuration data, wherein configuration data comprises monitoring configuration data specifying one or more database operations performed on one or more database tables in one or more databases and impact configuration data specifies how different events impact a plurality of data objects in a software system; generating a plurality of triggers based on the monitoring configuration data and storing the triggers in the one or more databases, wherein the triggers detect said one or more database operations on the one or more database tables; detecting, by the trigger, one or more database operations performed on the one or more database tables in the database; generating, in response to said detecting, one or more change events corresponding to the one or more database operations; processing the change events and the impact configuration data, and in accordance therewith, retrieving data from the database associated with one or more database objects impacted by the detected one or more database operations; storing the data associated with the one or more database objects in a repository; generating, based on the data associated with the one or more database objects, one or more corresponding notifications, wherein the notifications comprise at least a portion of the data associated with one or more database objects; storing the notifications in a memory; and sending the notifications to one or more users.

Example 2. In one embodiment, the present disclosure includes a method, system, or computer readable medium of example 1, wherein the monitoring configuration data specifies one or more columns, one or more database operations, and one or more database tables.

Example 3. In one embodiment, the present disclosure includes a method, system, or computer readable medium of examples 1-2 in any combination, wherein the change events are generated when the specified database operations are performed on the specified columns in the specified table.

Example 4. In one embodiment, the present disclosure includes a method, system, or computer readable medium of examples 1-3 in any combination, wherein generating the plurality of triggers comprises parsing the monitoring configuration data to produce the plurality of triggers.

Example 5. In one embodiment, the present disclosure includes a method, system, or computer readable medium of examples 1-4 in any combination, further comprising: monitoring changes in the monitoring configuration data; and automatically re-generating triggers when changes to the monitoring configuration data are detected.

Example 6. In one embodiment, the present disclosure includes a method, system, or computer readable medium of examples 1-5 in any combination, wherein the plurality of triggers are SQL triggers.

Example 7. In one embodiment, the present disclosure includes a method, system, or computer readable medium of examples 1-6 in any combination, wherein the change events correspond to a documentation update or a quantity change.

Example 8. In one embodiment, the present disclosure includes a method, system, or computer readable medium of examples 1-8 in any combination, wherein the change events comprises a previous value, a new value, and a time stamp.

Example 9. In one embodiment, the present disclosure includes a method, system, or computer readable medium of examples 1-9 in any combination, further comprising storing the change events in a temporary table.

Example 10. In one embodiment, the present disclosure includes a method, system, or computer readable medium of examples 1-9 in any combination, further comprising processing the change events to produce refined change events, where the processing associates additional data with the change events.

Example 11. In one embodiment, the present disclosure includes a method, system, or computer readable medium of examples 1-10 in any combination, wherein the processing is performed on a portion of change events in parallel by a plurality of event consumers.

Example 12. In one embodiment, the present disclosure includes a method, system, or computer readable medium of examples 1-11 in any combination, wherein the impact configuration data comprises user defined logic to specify how change events impact the database objects.

Example 13. In one embodiment, the present disclosure includes a method, system, or computer readable medium of examples 1-12 in any combination, wherein the logic comprises an equation for combining elements of at least one event.

Example 14. In one embodiment, the present disclosure includes a method, system, or computer readable medium of examples 1-13 in any combination, wherein the logic fetches additional data from the database for particular events to determine how the particular events impact the database objects;

Example 15. In one embodiment, the present disclosure includes a method, system, or computer readable medium of examples 1-14 in any combination, wherein processing the change events and the impact configuration data comprises generating a list of database objects impacted by the change events.

Example 16. In one embodiment, the present disclosure includes a method, system, or computer readable medium of examples 1-15 in any combination, wherein processing the change events and the impact configuration data comprises generating an impacted object record comprising one or more data elements indicating a change in a data value resulting from the detected at least one of the database operations.

Example 17. In one embodiment the present disclosure includes a method, system, or computer readable medium of examples 1-16 in any combination, wherein the impact configuration data specifies a change type and one or more affected roles, and wherein the impacted object record further comprises an object identifier, the change type, and the one or more affected roles.

Example 18. In one embodiment the present disclosure includes a method, system, or computer readable medium of examples 1-17 in any combination, wherein the impact configuration data specifies a regular expression, and wherein the impacted object record comprises an evaluation of the regular expression based on one or more change events.

Example 19. In one embodiment, the present disclosure includes a method, system, or computer readable medium of examples 1-18 in any combination, wherein generating the notifications comprises extracting data from the impacted object record to produce a text string, and wherein the notification comprises the text string.

Example 20. In one embodiment, the present disclosure includes a method, system, or computer readable medium of examples 1-19 in any combination, further comprising aggregating the notifications, wherein at least a portion of the notifications sent to the one or more users are aggregated notifications.

Example 21. In one embodiment, the present disclosure includes a method, system, or computer readable medium of examples 1-20 in any combination, wherein aggregating the notifications comprises: determining that a first portion of the notifications in the memory are related; and generating a new single text string based on the first portion of the notifications.

Example 22. In one embodiment, the present disclosure includes a method, system, or computer readable medium of examples 1-21 in any combination, wherein generating the notification further comprises: storing notification rules; and processing the data associated with the one or more database objects based on the notification rules to determine recipients of the notifications.

Example 23. In one embodiment, the present disclosure includes a method, system, or computer readable medium of examples 1-22 in any combination, wherein the notification rules are processed based on data in the one or more database objects.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
storing configuration data, wherein configuration data comprises monitoring configuration data specifying one or more database operations performed on one or more database tables in one or more databases and impact configuration data specifies how different events impact a plurality of data objects in a software system;
generating a plurality of triggers based on the monitoring configuration data and storing the triggers in the one or more databases, wherein the triggers detect said one or more database operations on the one or more database tables;
detecting, by the trigger, one or more database operations performed on the one or more database tables in the database;
generating, in response to said detecting, one or more change events corresponding to the one or more database operations;
processing the change events and the impact configuration data, and in accordance therewith, retrieving data from the database associated with one or more database objects impacted by the detected one or more database operations;
storing the data associated with the one or more database objects in a repository;
generating, based on the data associated with the one or more database objects, one or more corresponding notifications, wherein the notifications comprise at least a portion of the data associated with one or more database objects;
storing the notifications in a memory; and
sending the notifications to one or more users.

2. The method of claim 1, wherein the monitoring configuration data specifies one or more columns, one or more database operations, and one or more database tables.

3. The method of claim 2, wherein the change events are generated when the specified database operations are performed on the specified columns in the specified table.

4. The method of claim 1, wherein generating the plurality of triggers comprises parsing the monitoring configuration data to produce the plurality of triggers.

5. The method of claim 4, further comprising:
monitoring changes in the monitoring configuration data; and
automatically re-generating triggers when changes to the monitoring configuration data are detected.

6. The method of claim 4, wherein the plurality of triggers are SQL triggers.

7. The method of claim 1, wherein the change events correspond to a documentation update or a quantity change.

8. The method of claim 1, wherein the change events comprises a previous value, a new value, and a time stamp.

9. The method of claim 1, further comprising storing the change events in a temporary table.

10. The method of claim 9, further comprising processing the change events to produce refined change events, where the processing associates additional data with the change events.

11. The method of claim 10, wherein the processing is performed on a portion of change events in parallel by a plurality of event consumers.

12. The method of claim 1, wherein the impact configuration data comprises user defined logic to specify how change events impact the database objects.

13. The method of claim 12, wherein the logic comprises an equation for combining elements of at least one event.

14. The method of claim 12, wherein the logic fetches additional data from the database for particular events to determine how the particular events impact the database objects.

15. The method of claim 1, wherein processing the change events and the impact configuration data comprises generating a list of database objects impacted by the change events.

16. The method of claim 1, wherein processing the change events and the impact configuration data comprises generating an impacted object record comprising one or more data elements indicating a change in a data value resulting from the detected at least one of the database operations.

17. The method of claim 16, wherein the impact configuration data specifies a change type and one or more affected roles, and wherein the impacted object record further comprises an object identifier, the change type, and the one or more affected roles.

18. The method of claim 16, wherein the impact configuration data specifies a regular expression, and wherein the impacted object record comprises an evaluation of the regular expression based on one or more change events.

19. The method of claim 16, wherein generating the notifications comprises extracting data from the impacted object record to produce a text string, and wherein the notification comprises the text string.

20. The method of claim 1, further comprising aggregating the notifications, wherein at least a portion of the notifications sent to the one or more users are aggregated notifications.

21. The method of claim 20, wherein aggregating the notifications comprises:
determining that a first portion of the notifications in the memory are related; and
generating a new single text string based on the first portion of the notifications.

22. The method of claim 1, wherein generating the notification further comprises:
storing notification rules; and
processing the data associated with the one or more database objects based on the notification rules to determine recipients of the notifications.

23. The method of claim 22, wherein the notification rules are processed based on data in the one or more database objects.

2. A computer system comprising:
at least one processor;
at least one non-transitory computer-readable medium storing computer-executable instructions that, when executed by the at least one processor, cause the computer system to execute a method comprising:
storing configuration data, wherein configuration data comprises monitoring configuration data specifying one or more database operations performed on one or more database tables in one or more databases and impact configuration data specifies how different events impact a plurality of data objects in a software system;
generating a plurality of triggers based on the monitoring configuration data and storing the triggers in the one or more databases, wherein the triggers detect said one or more database operations on the one or more database tables;
detecting, by the trigger, one or more database operations performed on the one or more database tables in the database;
generating, in response to said detecting, one or more change events corresponding to the one or more database operations;
processing the change events and the impact configuration data, and in accordance therewith, retrieving data from the database associated with one or more database objects impacted by the detected one or more database operations;
storing the data associated with the one or more database objects in a repository;
generating, based on the data associated with the one or more database objects, one or more corresponding notifications, wherein the notifications comprise at least a portion of the data associated with one or more database objects;
storing the notifications in a memory; and
sending the notifications to one or more users.

3. A non-transitory computer-readable medium storing computer-executable instructions that, when executed by at least one processor of a computer system, cause the computer system to execute method comprising:
storing configuration data, wherein configuration data comprises monitoring configuration data specifying one or more database operations performed on one or more database tables in one or more databases and impact configuration data specifies how different events impact a plurality of data objects in a software system;
generating a plurality of triggers based on the monitoring configuration data and storing the triggers in the one or more databases, wherein the triggers detect said one or more database operations on the one or more database tables;
detecting, by the trigger, one or more database operations performed on the one or more database tables in the database;
generating, in response to said detecting, one or more change events corresponding to the one or more database operations;
processing the change events and the impact configuration data, and in accordance therewith, retrieving data from the database associated with one or more database objects impacted by the detected one or more database operations;
storing the data associated with the one or more database objects in a repository;
generating, based on the data associated with the one or more database objects, one or more corresponding notifications, wherein the notifications comprise at least a portion of the data associated with one or more database objects;
storing the notifications in a memory; and
sending the notifications to one or more users.
